(19) United States
(12) Patent Application Publication
(10) Pub. No.: US 2003/0020436 A1
(43) Pub. Date: Jan. 30, 2003

(54) Switched reluctance generator and a method of controlling such a generator

(76) Inventors: Jeffrey Ronald Coles, Solihull (GB); Connel Brett Williams, Warwickshire (GB)

Correspondence Address: Mintz Levin Cohn Ferris, Glovsky & Popeo, One Fountain Square Suite 400, 11911 Freedom Drive, Reston, VA, 20190, US

(21) Appl. No.: 10/148,233

(22) PCT Filed: Dec. 5, 2000
(86) PCT No.: PCT/GB00/04658

(30) Foreign Application Priority Data
Dec. 6, 1999 (GB) 9928843.3

(51) Int. Cl. H02P 9/00

(52) U.S. Cl. 322/44

(57) ABSTRACT

A switched reluctance generator is provided in association with a controller (86 to 90). The controller is organized to operate in two modes depending on the speed and load of the generator. One mode is a discontinuous conduction mode where the current is a generator winding periodically returns to zero, whereas the other mode is a continuous conduction mode such that current is always flowing. The choice of modes enables a generator to work over a wide speed range while seeking to limit or reduce the volt-amp rating of the generator controller.

The present invention relates to a switched reluctance generator and to a method of controlling such a generator.

Switched reluctance machines are becoming more popular both for use as motors and generators.

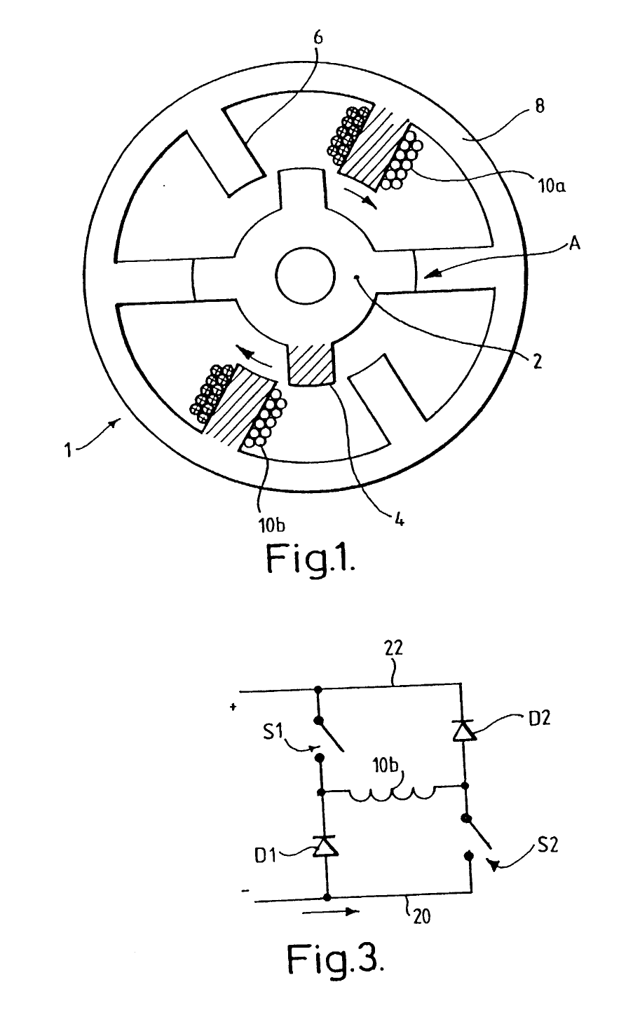

As shown in FIG. 1, a switched reluctance machine 1 comprises a rotor 2 carrying a plurality of salient poles 4 thereon. A co-operating plurality of salient poles 6 provided on a stator 8 carry respective windings 10a, 10b and so on. For convenience, the windings are often arranged in diametrically opposite pairs. From the above description, it will be apparent that the rotor is, in essence, merely a rotating mass of metal which does not carry any windings, magnets or have electrical connections made thereto. It is this feature which allows a switched reluctance machine to work at relatively high speeds in a hostile environment.

As the rotor rotates, each salient pole thereon moves between an aligned position, as indicated by “A” with respect to a stator pole, and an unaligned position where the stator pole is equidistant between adjacent rotor poles. In order to understand the generation of electricity using a switched reluctance machine, consider the motion of a rotor pole as it moves from an unaligned position through an aligned position and back to an unaligned position. In order to generate electricity from such a machine, it is necessary to control the supply of current to and withdrawal of current from the coils. FIG. 3 illustrates a drive circuit for a single stator coil 10b. As shown in FIG. 3, a first rectifier D1 is connected in series with a first switch S1 between a negative supply rail 20 and a positive supply rail 22, respectively, of a distribution bus. The rectifier D1 has its anode connected to the negative rail 20. A second switch S2 is connected in series with a second rectifier D2 between the negative rail 20 and a positive rail 22, with the rectifier D2 having its cathode connected to the positive rail 22. The stator winding 10b is connected between the cathode of the first rectifier D1 and the anode of the second rectifier D2.

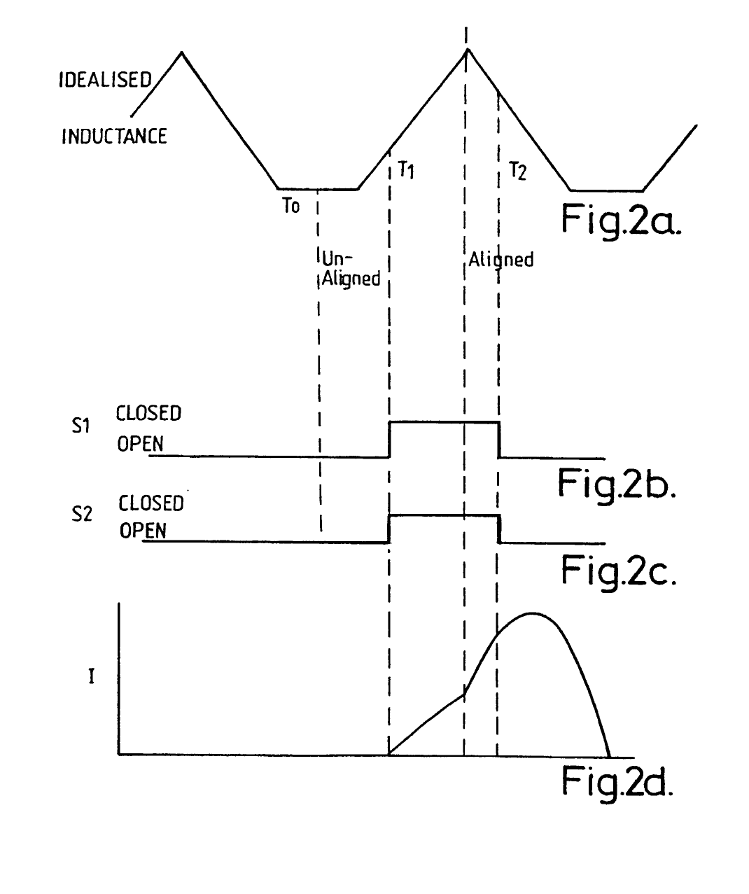

Referring to FIGS. 2 and 3, the generation cycle starts at time T0 where the rotor pole is at an unaligned position. As the rotor pole moves towards the stator pole, the magnetic gap between the poles decreases. Magnetic linkage between the rotor pole and stator pole causes the inductance of the winding 10b to vary between a maximum value when the poles are aligned, and a minimum value corresponding to the unaligned position. The idealised inductance is schematically illustrated in FIG. 2a.

As the rotor pole approaches the stator pole, the switches S1 and S2 are closed at period T1 in order to energise the stator coil 10b. The state of the switches are illustrated in FIGS. 2b and 2c. The current builds in the coil. Once the rotor and stator poles become aligned, the inductance starts to decrease. The current in the coil continues to build until such time as the current reaches a predetermined threshold (set by the system designer) which, in this example, occurs at time T2. At time T2, the switches S1 and S2 are opened. The current carrying coil is now open circuited and a negative voltage is generated. This, coupled with the reduction in flux as the stator and rotor poles move apart, causes the diodes to conduct, delivering the energy to the DC link. However, it will be appreciated that the collapsing magnetic field eventually means that the current falls to zero. An example current wave form during such a cycle is schematically plotted in FIG. 2D. Once the current has fallen to zero, the cycle is repeated. This scheme allows more energy to be delivered to the bus than was extracted from it, and consequently mechanical energy is converted into electrical energy.

The scheme described above works fine provided that the current can return to zero between each cycle. This can be achieved whilst the rotational rate of the machine is relatively slow, but as the rotational rate increases, the cycle time decreases. Eventually there becomes a point where one cycle cannot complete fully before the next one is scheduled to start. If the control is not handled properly, this could lead to progressive growth of current between successive operating cycles.

U.S. Pat. No. 5,469,039 discloses an arrangement in which the current in each phase winding of a switched reluctance generator is non-zero throughout its phase period, and the volt-seconds applied to the windings in each phase period are controlled by a controller in response to signals received from position sensing means to inhibit progressive flux growth in the windings by actuation of switches. The output of the generator is monitored by a feedback controller, and if the generator voltage falls due to an increase in demand, the switch on angle 2^{on} is reduced, ie switch on is advanced, thereby allowing the flux and current in the generator phases to build up successively until the current supply exceeds the new level of load. The error signal supplied by the feed back controller will then retard the switch on angle in order to maintain the generator at the new quiescent state.

Although this document teaches a control strategy for using a switched reluctance generator over a reasonably widely varying speed range there is no teaching nor suggestion that the physical size of the controller has been considered, nor has any attempt been made to minimise the current flowing.

U.S. Pat. No. 5,850,133 discloses a control strategy in which the controller operates to continuously maintain a current flowing in the stator coils of a switched reluctance generator irrespective of the rotational speed during overload conditions.

U.S. Pat. No. 5,493,195 discloses a switched reluctance machine in which the scheduled turn on and turn off angles are fixed and current control is achieved by operating the associated switches to maintain the current in the coil between upper and lower control thresholds. If the bus voltage rises, then the upper current threshold value is reduced. If mere generator reduction fails to hold the bus voltage at an acceptable level, high voltage excursions can be controlled by advancing the on angle to approximately 200° before alignment so as to enter a “quasi motoring mode”.

According to a first aspect of the present invention, there is provided a method of controlling the operation of a switched reluctance generator so as to reduce the volt-amp rating of a controller, in which the controller operates in a first mode for rotational rates below a threshold determined as a function of rotational speed and load and a second mode for rotational rates at or above the said threshold, and in which in the first mode the current supplied to a stator winding is modulated to limit the peak value of the current to a limit current value, and in the second mode the duration, minimum value or maximum value of a supply of current to a winding is varied in response to demand, the current not returning to zero during a control cycle where a rotor pole approaches and then moves away from the winding.

It is thus possible to limit the peak current flowing in the switches of the controller. This is significant since it impacts upon the size and cooling requirements of the controller.

If it is desired to operate the machine in the second mode at all speeds, the threshold may be set to zero speed and/or zero load.

It will be appreciated that the travel of the rotor from a position where a first rotor pole is aligned with a stator pole to a position where a neighbouring rotor pole is aligned with the said stator pole constitutes one complete electrical cycle and hence one complete control cycle. Thus there are N electrical cycles for each complete rotation of the rotor, where N is the number of rotor poles.

Throughout this description reference will be made to various phase angles, which are measured with respect to the commencement of an electrical cycle.

Preferably, in the first mode, the switches are turned on at a predetermined phase angle θ=θ_{ON}, the current begins to rise and is monitored until such time as the current I reaches a predetermined value I_{TH1}. The switches are then turned off.

For the period intermediate the time when the current I first reaches I_{TH1} and the time when the phase angle reaches a turn-off angle θ=θ_{OFF}, the current is chopped so as to maintain it within a range having an upper threshold I_{TH2} and a lower threshold I_{TH3}. If the current I is greater than or equal to I_{TH2} both switches are turned off and if the current I is less than I_{TH3} one of switches is turned on so as to allow current to “freewheel”. I_{TH3} may be set equal to I_{TH2}. I_{TH2} may be equal to or less than I_{TH1}

Once the phase angle reaches θ=θ_{OFF}, both switches are opened, thereby causing the winding to return its energy to the supply bus.

Preferably, in the second mode, both switches are turned on at θ=θ_{ON}, and both switches are turned off when the current I is equal to or greater than a threshold I_{TH4} or when θ=θ_{OFF}.

I_{TH4} may equal I_{TH1}. I_{TH1} may be a variable value corresponding to a demand current from the generator. The demand current is the current required to service the total load connected to the generator when the generator is operating at it's nominal output voltage.

It will be appreciated that there is an interaction between the control strategies used to control a switched reluctance generator and either the maximum output of that generator for a given speed or the winding requirements for the poles. This can be seen by considering the opposing requirements of operating at high speed and at low speed. In order to deliver power at high speed with a conventional control strategy it is necessary only to have a low number of turns in a phase winding so that the current can build and decay rapidly. However if such a generator has to operate over a wide speed range, say 5:1 or 10:1, then a very large current would be needed at low speeds when delivering maximum power. By allowing the current to be conducted continuously when operating at high speed, the number of turns in the coil can be increased, thereby reducing low speed current levels whilst still achieving full power at high speeds.

According to a second aspect of the present invention, there is provided a controller for a switched reluctance generator, the controller being arranged to control the flow of current in a plurality of stator coils in such a way as to reduce the volt-amp rating of the controller, in which the controller operates in a first mode for rotational rates below a mode threshold determined as a function of rotational speed and load and a second mode for rotational rates above the said threshold, and in which in the first mode the excitation current supplied to a stator coil is modulated to limit the peak value of the current to a limit current value, and in the second mode the duration, minimum or maximum value of a supply of excitation current to a coil is varied in response to a current demand from the generator, the current not returning to zero during a control cycle where a rotor pole approaches and moves away from the stator coil.

If it is desired to operate the machine in the second mode at all speeds, the threshold may be set to zero speed and/or zero load.

According to a third aspect of the present invention, there is provided a controller constituting on embodiment of the second aspect of the present invention in combination with a switched reluctance generator having an operating speed range varying such that the maximum design speed is at least five times greater than the minimum design speed.

According to a fourth aspect of the present invention, there is provided a switched reluctance generator comprising a plurality of stator poles, wherein at least one of the stator poles is provided with a primary winding for controlled connection to a supply rail, the generator further comprising variable magnetic bias means for providing a bias field.

It is thus possible to use a bias means to bias the operating point of a switched reluctance generator to a desired operating region of a flux versus current space of the generator.

The bias means may be provided at a position where it can provide a bias to the entirety of the generator.

Preferably the variable magnetic bias means comprises at least one coil which can be energised to generate a magnetic field.

Preferably the variable magnetic bias means comprises a plurality of secondary coils provided on or adjacent the stator poles in association with the primary windings.

The secondary coils may be formed by tapping the primary windings. However it is preferred that the secondary coils are separate coils as this allows the number of turns and wire diameter to be selected independently of the wire diameter of the primary windings, thereby enabling the secondary coils to be optimised for the function they perform.

Furthermore, the secondary coils can have more turns of thinner wire and this significantly reduces the current required to bias the generator to a desired operating region compared to continuously conducting current through the primary coils to maintain a similar magnetic field strength continuously around a stator pole.

It is further possible that the use of secondary coils to bias the generator so that it continues to work at high speed can reduce the constraint imposed on the number of turns on the primary coil, which in turn may allow more turns to be used thereby reducing the peak current that needs to flow through the coil at low operating speed. This further enables the volt-amp rating of the controller to be reduced.

Preferably the secondary coils are connected to a respective controller. This has significant advantages with regard to fault tolerance. In order to generate electricity from a switched reluctance generator, it is necessary to supply an excitation current. This is often provided from the main bus. If the bus voltage collapses it may be impossible to restart the generator.

The secondary windings may be connected to a respective excitation bus which may be powered from a battery or a permanent magnet generator, at least under start-up conditions. This can then be used to start the main generator bus since the changing magnetic gap as the rotor rotates enables a changing flux to be utilised to recommence generation. Additionally or alternatively the secondary windings may be switched by their controller so as to function as a generator in their own right. This enables the secondary windings to act as a secondary generator which may supply power to the main bus during a start-up phase and which may also be used to augment the output of the primary generator during low speed operation—thereby reducing the peak currents flowing in the primary winding. This further allows reductions in the volt-amp rating of the controller components associated with the primary windings.

The secondary coils are magnetically linked to the primary coil and the rotor by virtue of being cut by the same flux lines as those components. This enables the secondary coils to be used as sensing coils. The coils can provide information concerning the angular position of the rotor and/or may be used to monitor phase currents.

It is also possible to monitor the primary coil to infer the current flowing in the associated secondary coil, by virtue of the flux linkage between the coils and the fact that motion of the rotor will result in a cyclic flux variation.

According to a fifth aspect of the present invention, there is provided a controller for a switched reluctance generator wherein the generator has at least one primary coil associated with a respective pole and a variable magnetic field biasing device, in which the controller is arranged to monitor the performance of the generator and to operate the variable magnetic field biasing device in order to control the output of the generator.

The controller may monitor the bus voltage of a bus supplied by the generator and use this to form an error signal representative of the difference between a desired bus voltage and the actual bus voltage. The error signal can then be used to control the magnitude of the magnetic bias and/or the primary coil current. Preferably the controller controls the supply of current to a plurality of secondary coils in order to control the magnetic bias.

According to a sixth aspect of the present invention, there is provided a method of controlling a switched reluctance generator, the generator having a plurality of primary windings associated with respective poles, and a magnetic biasing device, the method comprising the steps of exciting the primary windings and delivering energy from the primary windings to a bus, and further monitoring the output of the generator and using a measure of the output to adjust the magnetic field provided by the biasing device or the primary windings in order to vary the generator output.

This control strategy may be used in conjunction with a primary winding current modulation scheme as described hereinbefore.

According to a seventh aspect, there is provided a controller according to any one of the second or fifth aspects in combination with a switched reluctance generator connected to a prime mover, the controller being arranged to monitor the voltage on a supply bus connected to the generator and arranged to progressively reduce generator output and/or switch the generator into a motor mode so as to limit the magnitude of high voltage excursions on the bus.

The present invention will further be described, by way of example, with reference to the accompanying drawings in which:

FIG. 1 is a schematic illustration of a switched reluctance machine;

FIGS. 2a to 2d illustrate an idealised inductance for the machine shown in FIG. 1, switch timing signals for two switches connected to the coil 10b of FIG. 1, and a plot of current versus time for current flowing through the coil 10b, respectively;

FIG. 3 schematically illustrates a switching circuit for the coil 10b;

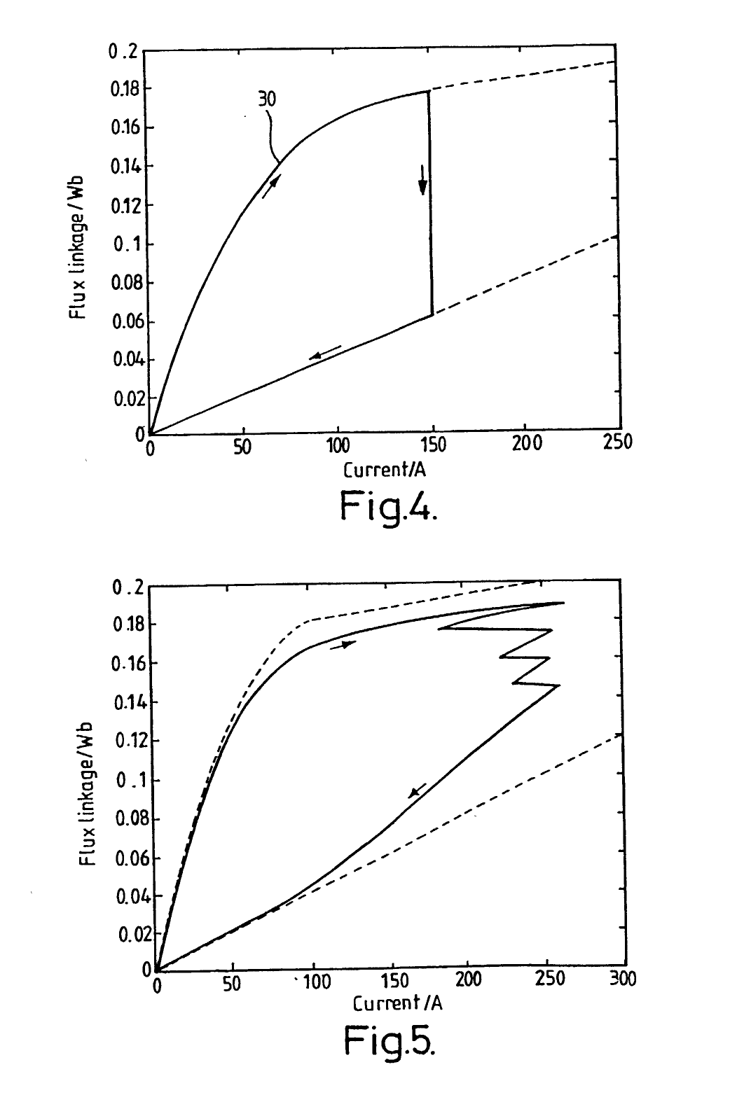

FIG. 4 schematically illustrates an idealised current versus flux linkage trajectory to achieve maximum power at low speed;

FIG. 5 illustrates an approximation to the curve shown in FIG. 4 for a system using a chopping current control and operating at full load;

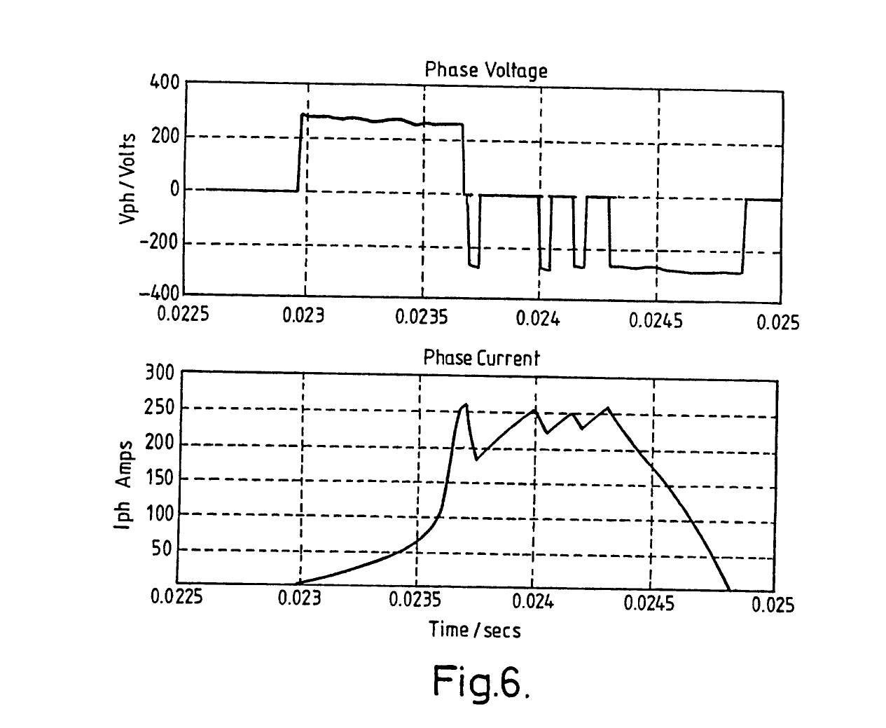

FIG. 6 schematically illustrates the phase voltage and phase current for the generator having the current versus flux linkage trajectory shown in FIG. 5;

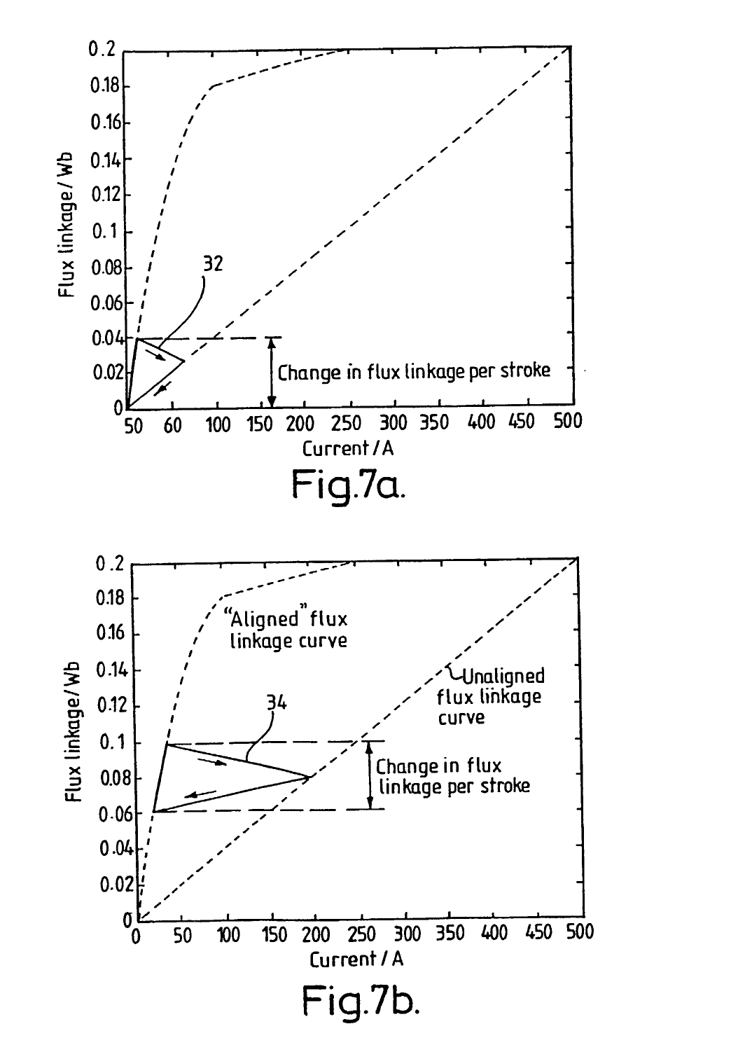

FIG. 7a and 7b schematically illustrate how a generator operating in a continuous magnetic field mode can deliver more energy per stroke;

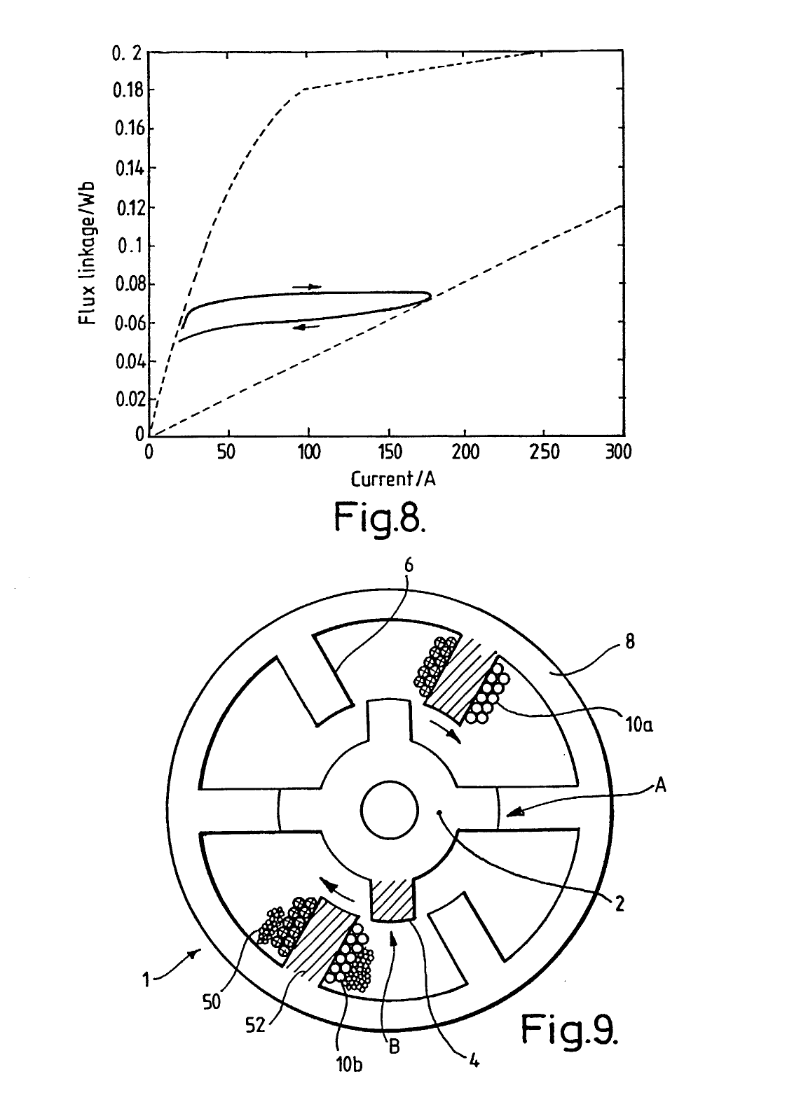

FIG. 8 schematically illustrates the current versus flux linkage trajectory for a generator running at full speed.

FIG. 9 is a cross-section through a generator having secondary windings and constituting an embodiment of the present invention;

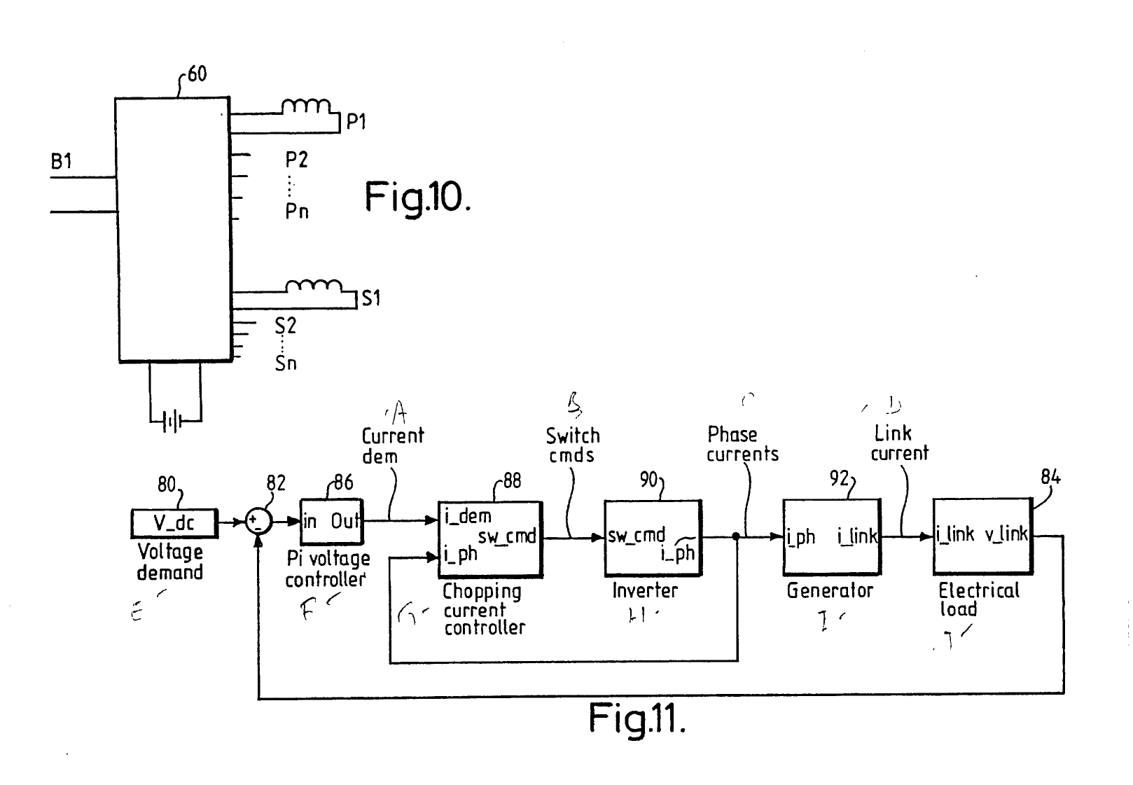

FIG. 10 schematically illustrates a controller constituting an embodiment of the present invention;

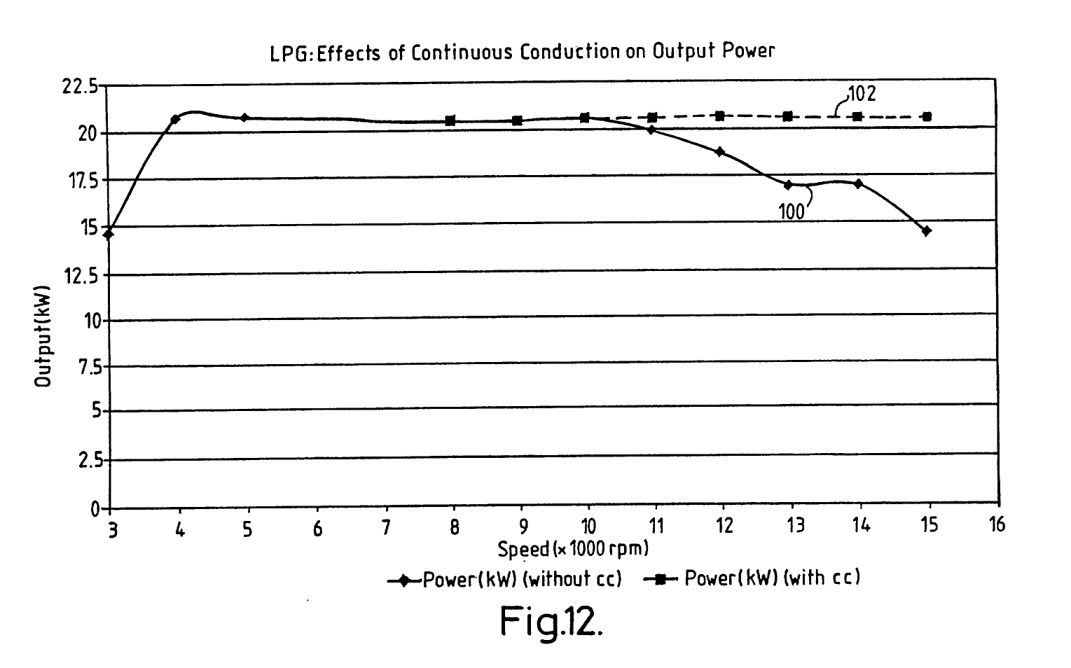

FIG. 11 schematically illustrates a block diagram for a SR generator system constituting a further embodiment of the present invention; and

FIG. 12 is a graph showing measured power output versus speed for a switched reluctance generator with a controller allowing the generator to enter into a continuous conduction mode.

It is known that switched reluctance generators can be controlled where their operational speed does not vary, or only varies a very small range. The present invention seeks to control the output of a switched reluctance generator over a wide speed range. It is contemplated that the present invention will be applied to a switched reluctance generator having a minimum speed of approximately 3,000 rpm and a maximum speed of in excess of 30,000 rpm, and probably nearer 40,000 rpm.

Ideally, the generator must be capable of producing constant voltage and power over the entire speed range of the machine. Since power for a given flux value increases with rotor speed, it will initially seem that the most difficult task is meeting the maximum power requirement at minimum speed. However, it is in fact relatively simple to design the generator to function correctly at either end of its speed range. The problem overcome by the present invention resides in getting the generator to work over a wide speed range.

To generate power, the stator coils are energised in a controlled manuer in order to generate a magnetic flux. This flux crosses the gap between the stator and rotor to induce magnetisation in the poles of the rotor. This in turn causes a variation in the flux surrounding the stator coil. As would be expected, the amount of energy produced by the switched reluctance generator is proportional to the change of flux linkage through the stator coil.

The switched reluctance machine produces a finite amount of energy per stroke. The stroke energy is the area enclosed by the flux linkage curve as a phase goes through one electrical cycle. An example of such a curve is shown in FIG. 4 where the stroke energy is proportional to the area enclosed by the line 30.

The stroke energy requirement at maximum power is given by:

$${W}_{STROKE} = \frac{{P}_{MAX}}{Ω}$$

Where:

W_{STROKE} is the stroke energy.

P_{MAX} is the maximum power generated, and

Ω is the rotor speed in revolutions per second.

It is apparent that the generator has to deliver the most energy per stroke when it is operating at its minimum speed.

Low speed operation has the potential to produce the highest phase currents in the windings because the large stroke energy required at maximum power makes it necessary to saturate the magnetic material which in turn requires large currents. In order to reduce the phase current, and consequently dissipation within a controller for the switched reluctance generator, it is desirable to choose a control strategy that minimises the phase current at low speed. FIG. 4 shows an idealised current versus flux trajectory at low speed in which the area contained within the curve is maximised for any particular current level.

In this idealised trajectory, the maximum current is built up in the winding at the aligned position, it is then held constant to the unaligned position and is then instantaneously reduced to zero. By integrating the flux linkage curves for one specific design of generator in a simulation package, it was shown that the minimum theoretical current required to produce an output of 25 kW at 3,000 rpm using the idealised trajectory is 188 amps.

If the voltage on the bus formed by rails 20 and 22 is held constant, the most practical way to achieve the idealised current trajectory is to use current control to hold the current approximately constant as the rotor moves from the aligned to the unaligned position. FIG. 5 schematically illustrates a simulation showing current in one phase of a switched reluctance generator operating at low speed and using a modulated current control scheme of which Delta modulation is an example. In this scheme, the switches S1 and S2 are switched on just before the aligned position is reached, thereby applying a positive voltage to the coil 10b and causing the current to increase. When the current reaches a set point demanded by a voltage feedback controller, switches S1 and S2 are opened thereby applying a negative voltage to the coil 10b and decreasing the phase current. When the current drops below the set point, one switch is turned on thereby short circuiting the coil which allows the current in the phase to increase again due to the generating action of the machine. The switch is repeatedly turned on and off in order to maintain the current around the set point until the turn-off angle is reached, at which point the switch is turned off and the phase current decays to zero. The trajectory shown in FIG. 5 does not perfectly follow the ideal current versus phase trajectory, and consequently the peak current is around 250 amps rather than the 188 amps for the ideal case. However, the current can be lowered by varying the switching times (ie switching angles) and the switching strategy. FIG. 6 illustrates a simulated voltage and current waveform for one phase of the generator operating at low speed and using delta modulation current control.

In practice, it is not always desirable to design the machine for the minimum possible phase current as this may result in unacceptable deterioration in other aspects of the machine's performance. Thus, in the above example, increasing the duration of the turn-on period would lower the phase current at the expense of increased voltage ripple.

It is also worth noting that, in the above simulation, the current is modulated at a fixed frequency of 20 kHz. However, the comparator that turned off the positive loop voltage when the current reached the set point operated asynchronously. This resulted, in the simulation, in a voltage ripple of around 20 volts peak to peak when smoothed by a 1,000 micro farad capacitor. However, if instantaneous set point detection was not implemented, and instead a determination of the current, and consequently the response, was made on a synchronous basis every 50 micro seconds such that the current control could be solely implemented within a digital current controller, considerable current overshoot could then occur which, in the simulation, increased the voltage ripple to around 35 peak to peak.

It will be appreciated that, as the rotational speed of the generator increases, each stroke is not required to produce so much energy. Thus for a doubling of rotational speed, each stroke only has to produce half the energy that was originally required. However, the coils of the generator are inductive and this limits the rate at which current flow can build and fall within the generator. Eventually, there is insufficient time to return the current to a zero value between successive generating cycles.

At high speed, the generator operates in a single pulse mode in which the positive link voltage is applied to the coil during the whole firing period. The flux linkage in the coil is proportional to the time integral of the phase voltage. As the speed increases, the magnitude of the applied voltage remains substantially constant, but the period of time that the voltage is applied for decreases. Hence the peak change in flux linkage per stroke is inversely proportional to generator speed.

FIG. 7a schematically illustrates a flux curve for the same generator as shown in FIG. 4, but operating at much higher speed. It will be seen that in this example, the flux peaks at 0.04 weber before starting to decay again. Thus the area enclosed by the flux curve 32 is much smaller than that enclosed by curve 30 and consequently the amount of energy produced in one stroke is much diminished.

To overcome this loss of output power, it is desirable to bias the generator to a different point on its operating curve. FIG. 7b schematically illustrates a flux curve 34 where the peak change in flux per stroke is identical to that in FIG. 7a but where the curve starts from a minimum value of 0.06 weber rather then zero. It is apparent that curve 34 encloses a larger area of the graph than curve 32 and consequently the energy delivered per stroke is greater. The coil 10b can be operated in a continuous conduction mode such that the coil itself generates the bias field. As a result, the coil is always conducting current. In order to achieve this, the dwell angle (ie the difference between turn-on and turn-off angles) is increased to approximately 180° electrical. In the ideal machine, continuous conduction would occur at exactly 180°, but in reality phase resistance and mutual coupling alter this such that the angle is normally slightly greater than 180°.

When the generator moves into a continuous conduction mode the transfer function of the generator effectively changes, thereby changing the closed loop transfer function. As a result, the control strategy chosen for the normal operating mode will not produce an identical transient response in the continuous conduction mode. However, the applicant has realised that in the case of a current chopping controller, it is possible to design a single controller that will produce a reasonable transient response in both operating modes. In a prototype machine operating from 3,000 rpm to 37,000 the dwell angle is scheduled with speed varying linearly from 150° at 3,000 rpm to 190° at 14,000 rpm and remaining constant at 190° up to maximum speed. Up to around 14,500 rpm, the machine operated in a pulsed mode. Above this speed, the prototype went into continuous conduction when the load was sufficiently high. Continuous conduction was invoked automatically when the scheduled dwell angle was such that the demanded current was not reached before the rotor had travelled 180° electrical. However, if the electrical load were lower then the demanded current would also be lower and the positive voltage would be cut off before 180° of travel had occurred, thereby preventing continuous conduction.

FIG. 8 shows the current versus flux trajectory for the switched reluctance generator running at maximum power (25 kW) and at maximum speed (37,000 rpm). Under these conditions, the machine is operating in a continuous conduction mode so that the current and flux linkage do not return to zero at the end of each stroke, and the energy loop is pushed up the flux linkage axis.

An advantage of the current chopping controller scheme is that it does not require high resolution or accuracy as regards the rotational position of the rotor. This makes it particularly suitable for use with simple position sensors, or even for use in schemes where position sensors are not provided and the rotor position is inferred from the voltages across and currents flowing in the stator coils.

It will be apparent than any controller for the coil necessarily includes real rather than idealised components. In order to obtain the operating speeds required, the switches are in fact transistor devices. These exhibit internal resistance and also have a voltage drop there across when fully on. Similarly, the diodes also exhibit a voltage drop when conducting.

This results in heat dissipation within these components. In the continuous conduction mode there will always be heat dissipation within the windings of the coil and the associated semiconductor components. This results in a requirement to provide sufficient heat sinking for the transistors in order to avoid thermal damage from occurring and may also result in the components being used in parallel in order that they can undertake some load sharing.

An alternative method of operating the generator in a continuous conduction mode involves the use of a biasing means separate from the primary stator windings.

Although permanent magnets could be provided, it is preferred that secondary coils of which only one labelled 50 is illustrated in FIG. 9 associated with pole 52, is provided for each stator pole. The secondary coil 50 is used to provide a magnetic bias to the generator. As such, the coil 50 is wound to optimise field generation properties rather than current carrying capabilities. The coil 50 may typically have 10 or more times the number of turns of the primary coil 10b since the rate of change of current in the secondary coil is much lower than that in the primary coils.

The generator controller has to be modified, as shown in FIG. 10 such that the controller 60 has switch connections to the primary coils P1, P2 to Pn and also the secondary coils S1, S2 to Sm. The number of secondary coils may be different to the number of primary coils. The controller 60 monitors the link voltage on the bus B1 and uses this in accordance with a predetermined control strategy, to vary the current flowing through the secondary coils in order to change the bias point of the generator along the flux curve.

In a preferred embodiment, a controller 60 is also connected to a battery back up supply 62 and/or a permanent magnet generator (not shown) for supplying current to the secondary coils. Such an arrangement increases the fault tolerance of the switched reluctance generator. In order to start a switched reluctance generator, it is necessary to energise the coils. If the link voltage should have collapsed completely, for example because the bus has short circuited, it becomes impossible to energise the primary coils. However, if the secondary coils have a separate supply, then these can be energised from the separate supply. Given that the secondary coils have many more turns, then the current drawn by the secondary coils to produce a given field strength is much reduced compared to the current required by the primary coils to obtain the same field strength. The rotary motion of the rotor ensures that the magnetic coupling between the rotor and the stator poles varies and as a result, the DC field produced by the secondary coils effectively becomes modulated. This causes the flux linkage to the primary coils to vary in a cyclic manner thereby providing the opportunity to generate current using the primary coils and thereby to re-establish the generator functionality.

The controller 60 can further be arranged such that the secondary coils are used at low speeds in order to augment the current generation from the primary coils. The maximum generating capability from the secondary coils may be chosen by the system designer, although it should be borne in mind that there may be conflict between obtaining reasonable current production from the secondary coils at low speed and in minimising the current required in the secondary coils to produce a given bias field for operation of the generator at high speed.

The primary coil 10b and the secondary coil 50 share the same magnetic circuit as one another and consequently the secondary coil can be used to sense the flux change resulting from or experienced by the primary coil. Thus the secondary coil can be used as a flux sensor to assist in sensorless control of the generator at low speed thus it may not be necessary to provide position sensors for the rotor.

The secondary coils may be connected in parallel, in which case they provide an equal assistance flux for each phase, or in series in which they provide an equal assisted current for each phase.

FIG. 11 illustrates a controller in which a reference 80 generates a demand voltage signal which is provided to a non-inverting input of the summer 82. An inverting input of the summer receives a measurement of the voltage appearing across an electrical load 84. The summer 82 forms an error signal representing the signal difference between the desired and actual voltages. The error signal is provided to an input of a proportional—integral controller 86 which generates a current demand signal. The current demand signal is provided to an input of a current controller 88 which also monitors the currents supplied to the phase windings 10a, 10b of the switched reluctance generator. The current controller produces switch commands which, in conjunction with data concerning the rotational position of the rotor (whether this is from position sensors or inferred from monitoring the output of the generator) is used to control the operation of the switches S1 and S2 in inverter 90 (as shown in FIG. 3). This then controls the action of the generator 92.

Aircraft carry several large electrical loads, such as de-icers and various actuators. Furthermore, some of the actuators may be regenerative and as a result, aerodynamic forces acting on flight surfaces connected to such actuators may cause energy to be delivered to the aircraft bus. Such regenerative effects and/or switching off of large loads may cause the aircraft bus voltage to rise rapidly. Aircraft do not have the luxury of carrying large batteries in order to smooth out voltage variations. Smoothing capacitors are provided, but these are heavy and have relatively small values given that they are typically of a ceramic type rather than an electrolytic type. The switched reluctance generator is driven from an engine spool, such as the low speed spool, and can be arranged by changing the turn on/turn off angles to switch to a motor mode to supply energy to the low speed spool during times of bus voltage overload in order to reduce the aircraft bus voltage. The generator controller in a current control system may be arranged to supply a motoring current which is equal to the generator current limit. In a voltage control system, the controller may be arranged to operate the generator as a motor in a pulse width modulated manner with the demand duty cycle set appropriately until such time as the voltage excursion is controlled. In either event, it is likely that some current limiting algorithm would be required to prevent excessive current in the winding occurring for too long a period.

The motoring switch on and switch off angles may be fixed, or alternatively they may be scheduled with speed.

Once the bus voltage excursion has been constrained and the voltage drops below a second threshold, the controller then returns the generator back to a generating mode with the demand current or demand voltage and commutation angles being returned to the values they were at before the over voltage occurred. The second threshold is advantageously different to the first (over voltage) threshold in order to introduce hysteresis into the system.

Such a technique has the advantage of providing over voltage protection without requiring additional hardware components since the hardware is already installed in order to provide the generator function. Furthermore, given that a switched reluctance machine can switch very rapidly between generating and motoring modes, over voltage protection can be provided rapidly with the excess energy being dumped back into the aircraft engines.

As noted hereinbefore, as the speed increases it becomes advantageous to enable the generator to enter a continuous conduction mode (or to provide magnetic bias) in order to maintain generator output. FIG. 12 shows measured data clearly illustrating this point.

In a continuous conduction mode, generator output starts to fall off at speeds in excess of 10,000 rpm, as represented by line 100. However, if continuous conduction is allowed then output is maintained constant up to 15,000 rpm, as indicated by line 102.

It is thus possible to provide a flexible switched reluctance generating system which is capable of delivering its full rated power output over a speed range varying by more than 10 times. Furthermore, it is also possible to reduce the size of the controller required to energise a switched reluctance generator compared to prior art controllers used with generators having comparable power outputs over a more limited speed range. The provision of secondary windings further provides enhanced fault tolerance and an enhanced ability to restart the generator in the event of a bus voltage collapse. The generator can also be used in a motor mode in order to provide bus voltage protection. It is thus possible to provide a switch reluctance generator and controller which serves as a flexible source of power and overload protection device.

It will also be appreciated by those skilled in the art that whilst the teachings of this document have been described as applied to wide speed range generators, substantially the same or similar techniques may be applied to wide speed range variable reluctance generators or to machines having a dual function as a motor and a generator at different speeds or in different operating circumstances.

1. A method of controlling the operation of a switched reluctance generator (1) so as to reduce the volt-amp rating of a controller (S1, S2, D1, D2, 88, 90) characterised in that the controller (S1, S2, D1, D2, 88, 90) operates in a first mode for rotational rates below a threshold determined as a function of rotational speed and load, and a second mode for rotational rates at or above said threshold, and in which in the first mode the current supplied to a stator winding (10a, 10b) is modulated to limit the peak value of the current to a limit current value, and in the second mode at least one of the duration, minimum value and maximum value of a supply of current to the stator winding (10a, 10b) is varied in response to demand, the current not returning to zero during a control cycle where a rotor pole approaches and then moves away from the winding.

2. A method as claimed in claim 1, characterised in that the threshold can be set to one of zero speed and zero load so as to cause the switched reluctance generator to operate in the second mode at all speeds.

3. A method as claimed in claim 1 or 2, characterised in that in the first mode switches (S1, S2) are turned on at a predetermined phase angle (θon) and the current in the winding (10b) is monitored, and the switches (S1, S2) are turned off when the current reaches a predetermined value I_{TH1}.

4. A method as claimed in claim 3, characterised in that the current in the winding (10b) is modulated so as to limit its excursions outside a range having an upper threshold (I_{TH2}) and a lower threshold (I_{TH3}) during a time period commencing when the current first reaches the value (I_{TH1}) and ending when the phase angle reaches a turn-off angle (θoff).

5. A method as claimed in claim 4, characterised in that the controller (90) controls the switches (S1, S2) such that if the current in the winding (10b) exceeds or is equal to the upper threshold (I_{TH2}) then both switches (S1, S2) are turned off and if the current in the winding (10b) is less than the lower threshold (T_{TH3}) then one of the switches (S1, S2) is turned on whilst the other one of the switches (S1, S2) is off so as to allow the current to “freewheel”.

6. A method as claimed in claim 5, characterised in that the upper threshold (I_{TH2}) is set equal to the lower threshold (I_{TH3}), and the upper threshold (I_{TH2}) is less than or equal to the predetermined value (I_{TH1}).

7. A method as claimed in any one claims 3 to 6, characterised in that both switches (S1, S2) are opened once the phase angle reaches the turn-off angle (θoff) thereby causing the winding (10b) to supply energy to a supply bus (20, 22).

8. A method as claimed in any one of the preceding claims, characterised in that, in the second mode, the switches (S1, S2) are turned on when the phase angle reaches the turn-on angle (θon) and the switches (S1, S2) are turned off when the current flowing in the winding (10b) reaches a turn-off threshold (I_{TH4}) or when the phase angle reaches the turn off angle (θoff).

9. A method as claimed in claim 8, characterised in that the turn-off threshold (I_{TH4}) is equal to the predetermined value (I_{TH1}).

10. A method as claimed in any one of the preceding claims, characterised in that the predetermined value (I_{TH1}) is a variable calculated as a function of the demand current.

11. A controller (88, 90) for a switched reluctance generator (1) characterised in that the controller (88, 90) is arranged to control the flow of current in a plurality of stator coils (10a, 10b) in such a way as to reduce the volt-amp rating of the controller, in which the controller operates in a first mode for rotational rates below a mode threshold derived as a function of rotational speed and electrical load supplied by the generator (1), and in a second mode for rotational rates above said mode threshold, and in which in the first mode an excitation current supplied to a a stator coil (10b) is modulated to limit the peak value of current to a limit current value, and in the second mode at least one of the duration, minimum value and maximum value of the supply of the excitation current to the stator coil (10b) is varied in response to a current demand, the current flowing in the stator coil (10b) not returning to zero during a control cycle where a rotor pole approaches and moves away from the stator coil (10b).

12. A controller (88, 90) as claimed in claim 11, characterised in that the mode threshold value is set to zero.

13. A controller 88, 90) as claimed in claim 11 or 12, characterised in that the first mode switches (S1, S2) are turned on at a predetermined phase angle (θon) and the current in the winding (10b) is monitored, and the switches (S1, S2) are turned off when the current reaches a predetermined value I_{TH1}.

14. A controller (88, 90) as claimed in claim 13, characterised in that the current in the winding (10b) is modulated so as to limit its excursions outside a range having an upper threshold (I_{TH2}) and a lower threshold (I_{TH3}) during a time period commencing when the current first reaches the value (I_{TH1}) and ending when the phase angle reaches a turn-off angle (θoff).

15. A controller (88, 90) as claimed in claim 14, characterised in that the controller (90) controls the switches (S1, S2) such that if the current in the winding (10b) exceeds or is equal to the upper threshold (I_{TH2}) then both switches (S1, S2) are turned off and if the current in the winding (10b) is less than the lower threshold (I_{TH3}) then one of the switches (S1, S2) is turned on whilst the other one of the switches (S1, S2) is off so as to allow the current to “freewheel”.

16. A controller (88, 90) as claimed in claim 15, characterised in that the upper threshold (I_{TH2}) is set equal to the lower threshold (I_{TH3}), and the upper threshold (I_{TH2}) is less than or equal to the predetermined value (I_{TH1}).

17. A controller (88, 90) as claimed in any one claims 13 to 16, characterised in that both switches (S1, S2) are opened once the phase angle reaches the turn-off angle (θoff) thereby causing the winding (10b) to supply energy to a supply bus (20, 22).

18. A controller as claimed in any one of claims 11 to 17, characterised in that, in the second mode, the switches (S1, S2) are turned on when the phase angle reaches the turn-on angle (θon) and the switches (S1, S2) are turned off when the current flowing in the winding (10b) reaches a turn-off threshold (I_{TH4}) or when the phase angle reaches the turn off angle (θoff).

19. A controller as claimed in claim 18, characterised in that the turn-off threshold (I_{TH4}) is equal to the predetermined value (I_{Th1}).

20. A controller as claimed in any one of claims 11 to 19, characterised in that the predetermined value I_{TH1} is a variable calculated as a function of the demand current.

21. A controller as claimed in any one of claims 11 to 20 in combination with a switched reluctance generator (1) having an operating speed range in which the maximum design operating speed is at least five times greater than the minimum design operating speed.

22. A switched reluctance generator (1) comprising a plurality of stator poles (10a, 10b), wherein at least one of the stator poles is provided with a primary winding (10b) for controlled connection to a supply (20, 22), the generator further comprising variable magnetic biasing means (50) for providing a bias field.

23. A switched reluctance generator (1) as claimed in claim 22, characterised in that the biasing means is provided at a position where it can provide a bias to the entirety of the generator.

24. A switched reluctance generator as claimed in claim 22 or 23, characterised in that the variable magnetic bias means comprises at least one secondary coil (50) which can be energised to generate a magnetic field.

25. A switched reluctance generator as claimed in any one of claims 22 to 24, characterised in that the variable magnetic bias means comprises a plurality of secondary coils provided on or adjacent the stator poles in associating with primary windings (10a, 10b).

26. A switched reluctance generator as claimed in claim 25, characterised in that the secondary coils are formed by tapping in the primary windings.

27. A switched reluctance generator as claimed in claim 25, characterised in that the secondary coils are formed separately from the primary windings (10a, 10b).

28. A switched reluctance generator as claimed in any one of claims 22 to 27, characterised in that the secondary coils are used to provide a magnetic bias, thereby allowing more turns to be provided on the primary coils than would be possible for the same operating parameters if the biasing provided by the secondary coils was not provided.

29. A switched reluctance generator as claimed in any one of claims 24 to 28, characterised in that the secondary coils are connected to a controller (60) and the controller can energise the secondary coils to initiate operation of or to restart the generator.

30. A switched reluctance generator as claimed in claim 29, characterised in that the controller can connect the secondary coils to an associated excitation bus in order to induce a magnetic flux in the generator during initiation or restart.

31. A switched reluctance generator as claimed in claim 29 or 30, characterised in that the controller (60) can control the secondary coils so that they function to generate power.

32. A switched reluctance generator as claimed in claim 31, characterised in that the controller (60) uses the secondary coils (50) to generate power to augment the output of the primary windings (10a, 10b) thereby reducing the peak currents flowing in the primary windings.

33. A switched reluctance generator as claimed in any one of claims 24 to 32 in which the secondary coils (50) are used as sensing coils to monitor at least one of angular position of the rotor and currents in the primary windings.

34. A controller for a switched reluctance generator, characterised in that the generator has at least one primary coil (10a, 10b) associated with a respective pole and variable magnetic field biasing device (50) in which the controller (60) is arranged to monitor the performance of the generator and to vary the magnetic bias field in order to control the output of the generator.

35. A controller as claimed in claim 34 characterised in that the controller monitors the voltage of a bus supplied by the generator and compares this with a desired bus voltage in order to generate an error value which is then used to vary the magnitude of the magnetic bias or the current flowing in the primary windings so as to reduce the error value.

36. A method of controlling a switched reluctance generator (1), the generator having a plurality of primary windings (10a, 10b) associated with respective poles, and a magnetic biasing device, the method comprising the steps of exciting the primary windings and delivering energy from the primary windings to a bus, a monitoring the output of the generator and using a measurement of the output or a value derived therefrom to adjust the magnetic field provided by the biasing device (50) or the primary windings (10a, 10b) in order to vary the generator output.

37. A controller as claimed in any one of claims 11 to 21, 34 or 35, wherein the controller is in combination with a switched reluctance generator connected to a prime mover, and in which the controller (60) is arranged to monitor the voltage on a supply bus connected the generator and to progressively reduce generator output and/or switch the generator into a motor mode so as to limit the magnitude of voltage excursions on the bus.
